(19) United States
(12) Patent Application Publication
(10) Pub. No.: US 2012/0180027 A1
(43) Pub. Date: Jul. 12, 2012

(54) SOFTWARE VERIFICATION SYSTEM AND METHOD, AND COMPUTER-READABLE MEDIUM FOR USE WITH THE METHOD

(75) Inventors: Yuan-Chang Yu, Longtan Township (TW); Tsung-Chieh Cheng, Longtan Township (TW); Ming-Huei Chen, Longtan Township (TW)

(73) Assignee: INSTITUTE OF NUCLEAR ENERGY RESEARCH, ATOMIC ENERGY COUNCIL, EXECUTIVE YUAN, Longtan Township (TW)

(21) Appl. No.: 13/075,908

(22) Filed: Mar. 30, 2011

(30) Foreign Application Priority Data
Jan. 7, 2011 (TW) 100100605

(51) Int. Cl. G06F 9/44

(52) U.S. Cl. 717/126

(57) ABSTRACT

It is described a software verification system and a method for determining anew, upon detection that key characteristics fail an acceptance criteria test, key characteristics and acceptance criteria thereof required for an ensuing verification procedure, so as to perform a spiral verification procedure. Thus, the system and method overcome drawbacks of conventional verification solutions, improve consistency in requirements for budgets and schedules of a verification project, optimize use of resources, maintain the quality of software verification services, enhance the quality of key-controlled services and products, and increase the chance of performing the project successfully. A computer-readable medium for use with the method is further provided.

### CROSS-REFERENCE TO RELATED APPLICATION

This non-provisional application claims priority under 35 U.S.C. §119(a) on Patent Application No(s). 100100605 filed in Taiwan, R.O.C. on Jan. 7, 2011, the entire contents of which are hereby incorporated by reference.

### FIELD OF THE INVENTION

The present invention relates to software verification systems and methods, and computer-readable media for use with the methods, and more particularly, to a software verification system and method for performing a spiral verification step, and a computer-readable medium for use with the method.

### BACKGROUND OF THE INVENTION

In general, every software verification method is implemented in accordance with a software development procedure. A software development procedure comprises a rapid prototype model, an incremental model, and a waterfall model which are in wide use.

Software verification work carried out in accordance with a software development procedure usually has drawbacks as follows:

1. Software verification work carried out in accordance with a rapid prototype model development has to be revised repeatedly and is flawed with a lack of strict analysis and design, and in consequence it is impossible to control software development systematically. As a result, verification work is inefficient. Also, software verification work requires much manpower all the time, and in consequence project-related resources cannot be efficiently controlled.
2. Software verification work can also be carried out in accordance with an incremental model development. With software being divided into several portions to be designed, implemented, and tested, the portions of the software are developed in accordance with different development models before being integrated and verified. The portions of the software are incorporated into an existing system and framework one by one. The incoming portions of the software are not supposed to damage the fully integrated system and framework. As a result, software verification work is increasingly complicated, and it is impossible to evaluate the effect of the introduction of a new portion of the software upon the stability of the verified system.
3. Software verification work developed in accordance with a waterfall model is often delayed and developed in an overly idealistic manner, thereby not keeping pace with the modern software development trend. It is because software has to be developed in accordance with strict linear procedures and thus, before the completion of an ongoing development procedure, it is necessary to carry out verification work strictly. It is only after the preliminarily developed software has passed a verification test, can the next development stage begin; otherwise, the soft development work has to be revised until it passes the verification test.

In addition, the course of implementation of a project is typically flawed with limited resources in terms of manpower, budget, and allowable time. The resources required for product development usually account for the majority of the available resources. As a result, verification work is eventually implemented at the cost of the integrity and completeness of the verification work when the verification work is carried out in a short-handed manner or in a hurry.

Both software development work and software verification work have to be strictly carried out, because they are judged on their integrity and completeness, whether in law or in practice. This is especially true of a software verification method for use with key control services which, for example, entail using a medical apparatus, an automatic navigation system for aircrafts, a spacecraft control system, a vehicle control system, or an automatic control system for a nuclear power plant, because safety requirement is the main criteria for development of key control services.

Nonetheless, given the limited resources available to a project, implementation of related verification work seldom meets the quality requirement of the verification work itself, and in consequence the service quality, conforming rate, and stability of the software developed are greatly reduced.

### SUMMARY OF THE INVENTION

It is an objective of the present invention to provide a software verification system and method for dynamically adjusting implementation work (i.e., the number of loops of verification work) so as to optimize the use of resources, maintain the service quality of software verification work, and thereby enhance the quality of key control services and the success rate of a project.

Another objective of the present invention is to reduce the risks associated with development and verification work, and systematically, gradually reduce the likelihood that conflicts arise from software development.

In order to achieve the above and other objectives, the present invention provides a software verification system comprising: a verification item initializing module for determining at least a key characteristic and an acceptance criterion thereof according to a data type and attribute of a would-be verified system; a test verification procedure processing module for presenting the at least a key characteristic and the acceptance criteria thereof to an external test system according to a definition of the at least a key characteristic and the acceptance criteria thereof, so as for the external test system to test whether the acceptance criteria of each of the key characteristics passes an acceptance criteria test, perform an evidence supplementing procedure on the key characteristics which fail the acceptance criteria test, and record the test result; a repeatedly executing unit for determining anew, according to a test result of the test verification procedure processing module, a plan of an ensuing verification loop procedure with respect to the key characteristics which fail the acceptance criteria test, such that the test verification procedure processing module can adjust the key characteristics and the acceptance criteria thereof as needed so as to perform a spiral verification procedure, wherein the newly set key characteristics and the acceptance criteria thereof enable the test verification procedure processing module to conduct the acceptance criteria test on each of the key characteristics; and a verification result processing unit for integrating all the test results and sending out a result report.

Preferably, the repeatedly executing unit performs forward inference in accordance with Bayesian principles to thereby build a Bayesian Belief Network (BBN) estimation model for estimating resources required for an ensuing verification procedure.

In an embodiment of the present invention, the verification item initializing module comprises: a key characteristic configuring unit for choosing appropriate said key characteristics from a key characteristics database according to a data type and attribute of the would-be verified system, so as to set key characteristics of a project; and an acceptance criteria setting unit for choosing the acceptance criteria of each of the key characteristics of the project from an acceptance criteria database according to a data type and attribute of the would-be verified system.

In an embodiment of the present invention, the test verification procedure processing module comprises: a testing unit for presenting, according to a definition of the at least a key characteristic and the acceptance criteria thereof, the at least a key characteristic and the acceptance criteria thereof to the external test system for testing and determining whether the acceptance criteria of each of the key characteristics passes the acceptance criteria; and an evidence supplementing unit for substituting data of previous operation for the acceptance criteria which fail the test, to allow the testing unit to test and determine, once again, whether the acceptance criteria pass the test.

In an embodiment of the present invention, a data input processing unit enters data types and attributes of the would-be verified system and stores the data types and attributes in an incoming database.

The present invention further provides a software verification method, comprising the steps of: searching for and collecting a data type and attribute of a would-be verified system; setting at least a key characteristic according to a technical norm of the would-be verified system and the data type and attribute collected; setting an acceptance criterion for each of the key characteristics according to the at least a key characteristic thus set; conducting, according to the acceptance criterion thus set, a test for determining whether the acceptance criterion of the key characteristics passes the test, followed by sending out a result report after all the acceptance criteria have passed the test, wherein data of previous operation substitute for the acceptance criteria which fail the test, and then the acceptance criteria test is conducted once again; and determining anew and according to the key characteristics which still fail the acceptance criteria test, upon completion of the acceptance criteria test conducted again, key characteristics and the acceptance criteria thereof required for an ensuing verification procedure, followed by conducting the acceptance criteria test on the newly set key characteristics and the acceptance criteria thereof.

Preferably, in the step of determining anew the key characteristics and the acceptance criteria thereof required for the ensuing verification procedure, forward inference is performed in accordance with Bayesian principles to thereby build a Bayesian Belief Network (BBN) estimation model for estimating resources required for the ensuing verification procedure.

In an embodiment of the present invention, in the step of setting at least a key characteristic, the key characteristics are set according to physical characteristics, performance characteristics, and dependability characteristics.

Furthermore, the present invention further provides a computer-readable medium stored therein with a program and configured to implement the software verification method after the program has been loaded to a computer and executed.

According to the present invention, software verification work related to key control services can be dynamically adjusted. With the software verification system and method of the present invention, software verification work can be efficiently carried out according to the extent a control system provides key control services.

In addition, a spiral software verification system is central to implementation of the present invention, and is effective in alternating between technical evaluation and acceptance process to thereby improve on conventional irreversible verification methods, such that verification work will meet the scheduled deadline and the quality requirements of a project even if the project is confronted with unpredictable project risks in the course of project development.

### BRIEF DESCRIPTION OF THE DRAWINGS

To enable persons skilled in the art to fully understand the objectives, features, and advantages of the present invention, the present invention is hereunder illustrated with specific embodiments in conjunction with the accompanying drawings, in which:

FIG. 1 is a schematic view of a software verification system according to an embodiment of the present invention; and

FIG. 2 is a flow chart of a software verification method according to an embodiment of the present invention.

### DETAILED DESCRIPTION OF THE PREFERRED EMBODIMENTS

Software is central to the control or execution of the service-related functions of a system, as control-oriented logic is always implemented through software development. Hence, it is important that software verification should be accurate and efficient.

In a software verification system where spiral software verification work is carried out according to a software verification method of the present invention, the procedure and the scale of execution of software verification work can be dynamically adjusted. With the software verification system and method of the present invention, software verification work can be efficiently carried out according to the extent a control system provides key control services.

A procedure of software verification operation involves technical evaluation and acceptance process. The technical evaluation entails searching for and collecting information related to a would-be verified system, performing technical assessment, setting key characteristics, planning verification strategy, and setting acceptance criteria for key characteristics. The acceptance process entails searching for, collecting, examining, evaluating, and verifying evidence of quality of key characteristics, replenishing the evidence of quality of key characteristics, and constructing a verification conclusion.

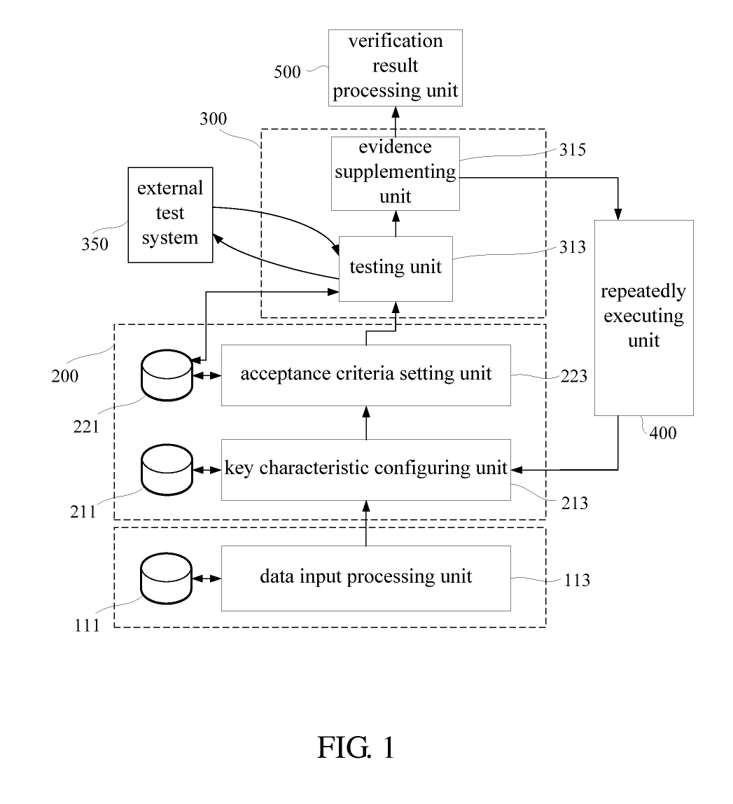

Referring to FIG. 1, there is shown a schematic view of a software verification system according to an embodiment of the present invention. As shown in the drawing, the software verification system of the present invention comprises a verification item initializing module 200, a test verification procedure processing module 300, a repeatedly executing unit 400, and a verification result processing unit 500.

The verification item initializing module 200 determines at least a key characteristic and an acceptance criterion thereof according to a data type and attribute of a would-be verified system. As shown in FIG. 1, preferably, the verification item initializing module 200 comprises a key characteristic configuring unit 213 and an acceptance criteria setting unit 223. The key characteristic configuring unit 213 chooses appropriate said at least a key characteristic from a key characteristics database 211 according to a data type and attribute of the would-be verified system, so as to set key characteristics of a project. The acceptance criteria setting unit 223 chooses an acceptance criterion of each of the key characteristics of the project from an acceptance criteria database 221 according to a data type and attribute of the would-be verified system. In addition, the key characteristic configuring unit 213 receives a planning result which is related to a planning strategy of an ensuing verification loop procedure and determined anew by the repeatedly executing unit 400, so as to adjust the key characteristics and the acceptance criteria thereof in the project anew. For example, it is feasible to evaluate and determine, according to the result of the test verification procedure processing module 300, whether the key characteristics at this stage or the acceptance criteria of the key characteristics have to be adjusted anew, so as to provide a reference for the key characteristic configuring unit 213.

Data types and attributes of the would-be verified system are usually related to hardware specifications, procedure rules, program code, written plans of software (firmware) development, or software (firmware) design documentation of the would-be verified system. In an embodiment of the present invention, the data types and attributes of the would-be verified system can be entered by a data input processing unit 113 and then stored in an incoming database 111. The key characteristic configuring unit 213 and the acceptance criteria setting unit 223 of the verification item initializing module 200 define and choose the related key characteristics and the acceptance criteria thereof from the key characteristics database 211 and the acceptance criteria database 221 according to keywords of the data types and attributes.

Key characteristics, which are set by the software verification system of the present invention in accordance with a technical norm of the system and entered reports, fall into three categories, namely physical characteristics, performance characteristics, and dependability characteristics.

(1) Requirements of physical characteristics essentially comprise interfaces, specifications, versions, labels, and appearance of a product.
(2) Requirements of performance characteristics essentially comprise functional requirement, efficacy requirement, environmental requirement (adverse versus moderate), and behavior arising from irregularity or malfunction.
(3) Requirements of dependability characteristics essentially comprise intrinsic quality, construction control, and retrospective requirement.

As regards mechanical and electrical apparatuses, their key characteristics are mainly physical characteristics and performance characteristics. However, in addition to physical characteristics and performance characteristics, key characteristics of software-controlled digital apparatuses are, to a greater extent, dependability characteristics. Hence, preferably, the most important key characteristics of a spiral software verification method are dependability characteristics.

It is impossible to verify the accuracy of dependability characteristics by inspection or a test. Dependability characteristics depend upon a development procedure of the apparatus at issue. Hardware failure occurs mainly because of a manufacturing fault and aging. There are sharp differences between hardware failure and software failure in terms of causes and characteristics. Software failure occurs mainly because of a design fault or non-compliance with application and need. Dependability characteristics include reliability and intrinsic quality, and depend upon a development procedure of a digital apparatus, a designer, verification and confirmation. The quality of a software system depends upon observance of a systematic development life cycle (requirement, design, implementation, and test), as well as hinges upon implementation of verification and confirmation and documentation within a development life cycle.

For example, key characteristics which are physical characteristics include dimensions in hardware specifications, and thus their acceptance criteria can involve recording the dimensions, such as length, width, and height, to confirm that procurement requirements are met. Key characteristics which are performance characteristics include environmental requirement (adverse versus moderate), such as humidity, and thus their acceptance criteria can involve examining an environment tolerance test report and determining whether the humidity requirement of a place of installation is met. Key characteristics which are dependability characteristics include design and design-related documentation, and thus their acceptance criteria can involve determining whether program execution is clearly defined and involve controlling a process flow and data stream.

The test verification procedure processing module 300 presents, according to the definition of the at least a key characteristic and the acceptance criteria thereof, the at least a key characteristic and the acceptance criteria thereof to an external test system 350, so as to test and determine whether the acceptance criteria of each of the key characteristics passes the acceptance criteria test, perform an evidence supplementing procedure on the key characteristics which fail the acceptance criteria test, and record the test result. Preferably, as shown in FIG. 1, the test verification procedure processing module comprises a testing unit 313 and an evidence supplementing unit 315. The testing unit 313 presents, according to the definition of the at least a key characteristic and the acceptance criteria thereof, the at least a key characteristic and the acceptance criteria thereof to the external test system 350 for testing and determining whether the acceptance criteria of each of the key characteristics passes the acceptance criteria. The evidence supplementing unit 315 substitutes data of previous operation for the acceptance criteria which fail the test, to allow the testing unit 313 to test and determine, once again, whether the acceptance criteria pass the test. Those key characteristics which have failed the acceptance criteria test are automatically evaluated by the evidence supplementing unit 315 to determine whether the acceptance standard should be replaced with data of previous operation. If, upon the evaluation, it is determined that substitution of the acceptance standard by data of previous operation is feasible, it will be deemed that the acceptance criteria have passed the test and have been replaced. The data of previous operation can be ones obtained in the same environment and associated with normal operation of software, and are free of any period of time during which an error occurs. In general, key control services anticipate 300 million hours of previous operation. For example, those dependability characteristics which fail the acceptance criteria test conducted by the testing unit 313 will still be regarded as having passed the acceptance criteria test, provided that the software itself has high-quality data of previous operation, such as a satisfactorily stable operation period.

The evidence supplementing unit 315 further performs a statistical analysis of the acceptance criteria which pass the acceptance criteria test. If at least one of the acceptance criteria fails the acceptance criteria test, then the repeatedly executing unit 400 will continue with the verification procedure. Conversely, if all the acceptance criteria pass the acceptance criteria test, then the verification result processing unit 500 will integrate all the test results and send out a result report.

The repeatedly executing unit 400 determines anew, according to a test result of the evidence supplementing unit 315, a plan of an ensuing verification loop procedure with respect to the key characteristics which fail the acceptance criteria test, such that the key characteristic configuring unit 213 and the acceptance criteria setting unit 223 can adjust the key characteristics and the acceptance criteria thereof as needed, thereby allowing a verification procedure to be performed again according to the key characteristics and the acceptance criteria thereof which are newly set and more than are needed.

If the acceptance criteria still fail the new verification test, the repeatedly executing unit 400 will determine anew a third plan of the verification loop procedure unless and until all the acceptance criteria pass the verification test. In so doing, a spiral verification procedure is effectuated. Preferably, the repeatedly executing unit 400 performs forward inference in accordance with Bayesian principles to thereby build a Bayesian Belief Network (BBN) estimation model for estimating the resources required for an ensuing verification procedure and thus enable the key characteristic configuring unit 213 and the acceptance criteria setting unit 223 to adjust the key characteristics and the acceptance criteria thereof as needed according to the aforesaid network estimation model. A Bayesian Belief Network (BBN) is a directed acyclic graph (DAG) which essentially consists of two kinds of elements, namely vertices and directed edges which work in conjunction with a plurality of status probability tables. In the aforesaid directed graph, each vertex represents a random variable, and each directed edge defines the correlating or causal relationship between two variables. The probability of each of the statuses of a variable denoted by a vertex is stated in the probability table for the vertex. In short, the status probability tables for use with the directed graph describe the relationship between the variables and its extent. Each of the vertices is associated with a condition probability table that describes causality, and the numerical data shown in the table are either decided by experts or acquired by a statistical means. Once new evidence surfaces, all the vertex numerical values of the whole network will be immediately calculated and updated, whether forward (from a parent vertex to a child vertex) or backward (from a child vertex to a parent vertex). Hence, the present invention entails building a Bayesian network for estimating the resources required for an ensuing verification procedure.

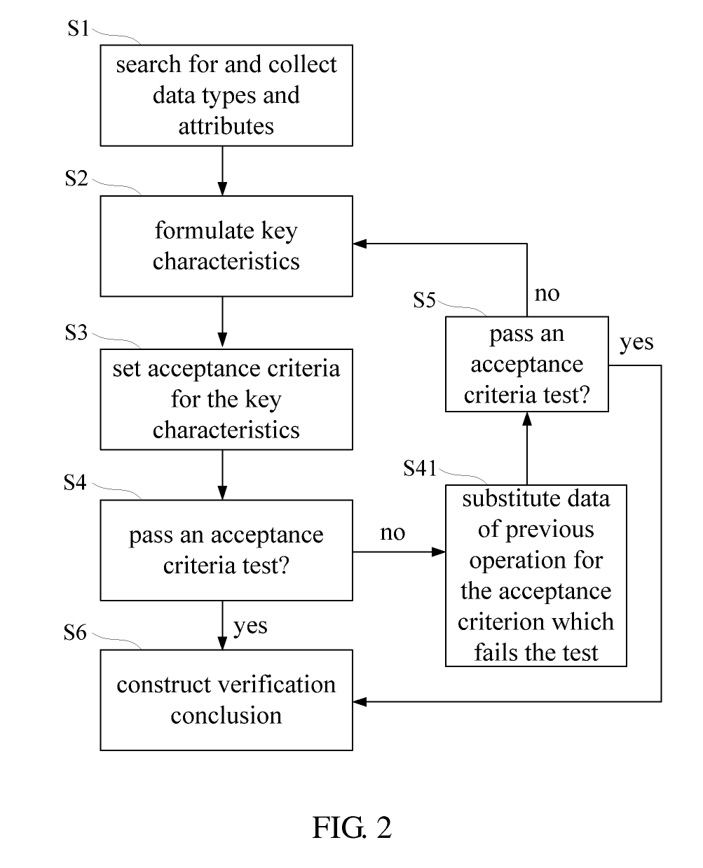

Referring to FIG. 2, there is shown a flow chart of a software verification method according to an embodiment of the present invention. As shown in the drawing, the software verification method comprises:

Step S1: searching for and collecting a data type and attribute of a would-be verified system.

Step S2: setting at least a key characteristic according to a technical norm of the would-be verified system and the data type and attribute collected.

Step S3: setting an acceptance criterion for each of the key characteristics according to the at least a key characteristic thus set; in general, a plurality of different acceptance criteria can apply to a single key characteristic.

Step S4: searching for, collecting, examining, evaluating, and verifying evidence of quality of key characteristics according to the acceptance criteria thus set, so as to conduct a test for determining whether the acceptance criteria of the key characteristics pass the test, and sending out a result report after all the acceptance criteria have passed the test;

Step S41: substituting data of previous operation for the acceptance criteria which fail the test and then conducting the acceptance criteria test once again.

Step S5: determining anew and according to the key characteristics which still fail the acceptance criteria test, upon completion of the acceptance criteria test conducted in step S41, key characteristics and the acceptance criteria thereof required for an ensuing verification procedure, followed by conducting the acceptance criteria test on the newly set key characteristics and the acceptance criteria thereof; meanwhile, it is not necessary to verify again the key characteristics and the acceptance criteria thereof which have already undergone the test.

Step S6: constructing verification conclusion, including integrating all the test results and sending out a result report. The contents of the report may include: a conclusive description of the spiral software verification work, a conclusive description of irregularities and solutions, integrated evaluation of software quality, and suggestions.

Accordingly, a spiral software verification system for key control services is implemented in three stages. In the first stage, the would-be verified system-related data are entered. In the second stage, verification work including the aforesaid technical evaluation and acceptance process is performed by taking five steps: performing technical evaluation and determining key characteristics (step S2); planning verification strategy and setting key characteristics and the acceptance criteria thereof (step S3); searching for, collecting, examining, evaluating, and verifying evidence of quality of key characteristics, followed by replenishing the evidence of quality of key characteristics (step S4); and performing verification work repeatedly (step S5). In the third stage, a verification conclusion is constructed (step S6). The second stage (step S2 through step S5) is crucial for implementation of the spiral software verification system, wherein technical evaluation alternates with acceptance process to thereby improve on conventional irreversible verification methods and dynamically adjust the work being executed (such as the number of working loops), such that verification work will meet the scheduled deadline and the quality requirements of a project even if the project is confronted with unpredictable project risks in the course of project development.

The incoming database 111, the key characteristics database 211, and the acceptance criteria database 221 can be integrated to form a single database.

Furthermore, in an embodiment, the software verification method of the present invention is configured to produce a program. The program thus produced is stored in a computer-readable medium. The program can be loaded to a computer and executed by the computer so as to implement the software verification method of the present invention.

In conclusion, the present invention provides a key control service-oriented software verification system and method, and a computer-readable medium for use with the method, so as to optimize the use of resources, maintain the service quality of software verification work, and thereby increase the success rate of a project. Characteristics of the present invention are as follows:

1. Software developed in accordance with a traditional rapid prototype model can be verified.
2. Software developed in accordance with a traditional waterfall model can be verified.
3. Verification takes place by a succession approach typical of software engineering, for example, starting from a software module, and then proceeding to daughter systems integral to the software module, until the system is verified in its entirety, thereby reducing conflicts which might otherwise arise from project development.
4. Software verification work is performed iteratively, that is, using a spiral verification method, so as to reduce risks associated with software development and verification work.
5. Execution of a software verification procedure features a feedback and evaluation mechanism which entails using a spiral verification method and applying Bayesian principles, so as to identify a problem and find a solution thereof before eventually constructing a verification conclusion.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

1. A software verification system, comprising:
a verification item initializing module for determining at least a key characteristic and an acceptance criterion thereof according to a data type and attribute of a would-be verified system;
a test verification procedure processing module for presenting the at least a key characteristic and the acceptance criterion thereof to an external test system according to a definition of the at least a key characteristic and the acceptance criterion thereof, so as for the external test system to test whether the acceptance criterion of each of the key characteristics passes an acceptance criteria test, perform an evidence supplementing procedure on the key characteristics which fail the acceptance criteria test, and record the test result;
a repeatedly executing unit for determining anew, according to a test result of the test verification procedure processing module, a plan of an ensuing verification loop procedure with respect to the key characteristics which fail the acceptance criteria test, such that the test verification procedure processing module can adjust the key characteristics and the acceptance criteria thereof as needed so as to perform a spiral verification procedure, wherein the newly set key characteristics and the acceptance criteria thereof enable the test verification procedure processing module to conduct the acceptance criteria test on each of the key characteristics; and
a verification result processing unit for integrating all the test results and sending out a result report.

2. The software verification system of claim 1, wherein the verification item initializing module comprises:
a key characteristic configuring unit for choosing appropriate said key characteristics from a key characteristics database according to a data type and attribute of the would-be verified system, so as to set key characteristics of a project; and
an acceptance criteria setting unit for choosing the acceptance criterion of each of the key characteristics of the project from an acceptance criteria database according to a data type and attribute of the would-be verified system.

3. The software verification system of claim 2, wherein the test verification procedure processing module comprises:
a testing unit for presenting, according to a definition of the at least a key characteristic and the acceptance criterion thereof, the at least a key characteristic and the acceptance criterion thereof to the external test system for testing and determining whether the acceptance criterion of each of the key characteristics passes the acceptance criterion; and
an evidence supplementing unit for substituting data of previous operation for the acceptance criteria which fail the test, to allow the testing unit to test and determine, once again, whether the acceptance criteria pass the test.

4. The software verification system of claim 1, wherein the repeatedly executing unit performs forward inference in accordance with Bayesian principles to thereby build a Bayesian Belief Network (BBN) estimation model for estimating resources required for an ensuing verification procedure.

5. The software verification system of claim 1, further comprising a data input processing unit for entering data types and attributes of the would-be verified system and storing the data types and attributes in an incoming database.

6. A software verification method, comprising the steps of:
searching for and collecting a data type and attribute of a would-be verified system;
setting at least a key characteristic according to a technical norm of the would-be verified system and the data type and attribute collected;
setting an acceptance criterion for each of the key characteristics according to the at least a key characteristic thus set;
conducting, according to the acceptance criteria thus set, a test for determining whether the acceptance criteria of the key characteristics pass the test, followed by sending out a result report after all the acceptance criteria have passed the test, wherein data of previous operation substitute for the acceptance criteria which fail the test, and then the acceptance criteria test is conducted once again; and
determining anew and according to the key characteristics which still fail the acceptance criteria test, upon completion of the acceptance criteria test conducted again, key characteristics and the acceptance criteria thereof required for an ensuing verification procedure, followed by conducting the acceptance criteria test on the newly set key characteristics and the acceptance criteria thereof.

7. The software verification method of claim 6, wherein, in the step of determining anew the key characteristics and the acceptance criteria thereof required for the ensuing verification procedure, forward inference is performed in accordance with Bayesian principles to thereby build a Bayesian Belief Network (BBN) estimation model for estimating resources required for the ensuing verification procedure.

8. The software verification method of claim 6, wherein, in the step of setting at least a key characteristic, the key characteristics are set according to physical characteristics, performance characteristics, and dependability characteristics.

9. A computer-readable medium, stored therein with a program and configured to implement the software verification method of one of claim 6 after the program has been loaded to a computer and executed.
